(19) United States
(12) Patent Application Publication
(10) Pub. No.: US 2015/0166385 A1
(43) Pub. Date: Jun. 18, 2015

(54) MOBILE WATER PURIFICATION SYSTEM AND METHOD

(71) Applicant: Hennesy Mechanical Sales, LLC, Phoenix, AZ (US)

(72) Inventors: Wesley C. Boerm, Phoenix, AZ (US); E. Patrick Hennesy, JR., Phoenix, AZ (US)

(73) Assignee: Hennesy Mechanical Sales, LLC, Phoenix, AZ (US)

(21) Appl. No.: 14/107,783

(22) Filed: Dec. 16, 2013

(51) Int. Cl. C02F 9/00; C02F 1/44; C02F 1/00; C02F 1/32; C02F 1/72

(52) U.S. Cl. CPC C02F 9/005; C02F 1/32; C02F 1/722; C02F 1/004; C02F 1/441

(57) ABSTRACT

A mobile water purification system is configured as modules to be air-lifted to a site requiring potable water. Raw water is pumped to a pre-treatment module that separates suspended solids and preferably oxidizes organic contaminants. At least one, and preferably two or more filtration modules coupled in parallel, then remove contaminants using ultrafiltration and/or reverse osmosis, and pass treated water to a storage tank. A control system operates valves to stagger backwashing of filtration modules, allowing one such module to be backwashed while allowing others to continue filtering water. The control system can selectively bypass a reverse osmosis unit, and disable related booster pumps, depending upon raw water quality. During backwash cycles, sodium bisulfite is added to fill water directed into ultrafiltration units to neutralize free chlorine present in backwash fluid.

### BACKGROUND OF THE INVENTION

1. Field of the Invention

The present invention relates generally to water treatment systems, and more particularly, to a water treatment system that is highly mobile and readily deployable.

2. Description of the Related Art

The production of safe drinking water from contaminated source water has been practiced for many years. Naturally occurring surface water is typically contaminated with particulate matter (sand, dirt, silt) and microorganisms from contact with wildlife. The salinity of water is highly variable from fresh water in streams to salt water in oceans. Often, water sources include contamination resulting from agricultural or industrial activities, including organic matter, bacteria, viruses, pesticides, herbicides, light hydrocarbons, MTBE, TCE, cyanide, and other harmful substances.

Most communities have stationary water treatment facilities designed to produce safe drinking water from source water available to the community. Natural disasters, including severe weather disturbances, can compromise the functionality of existing municipal water treatment facilities. Likewise, man-made disasters, either accidental or intentional in nature, can damage and/or disable existing water treatment facilities. When such disasters strike, it may become necessary for mobile water purification equipment to be deployed for disaster relief under the supervision of either private organizations such as the Red Cross, or a governmental agency such as the U.S. Federal Emergency Management Agency (FEMA).

Apart from disaster relief, there are also many areas in the world that are underdeveloped and have no water treatment infrastructure. People living and working in such areas require a source of clean water for drinking, washing, bathing and food preparation; mobile water purification systems have been deployed to fulfill such needs. Mobile water purification systems are also used to support military personnel stationed in remote regions.

Mobile water purification systems have been proposed in the past to treat source water of unknown and variable quality. However, the success of these systems has been limited. Early mobile systems simply used various medias to filter suspended solids from the water, and then chlorinated the resulting filtered water. These systems were ineffective for treatment of salt water or chemically contaminated water. The next generation of mobile water purification systems used reverse osmosis units to remove dissolved salts in sea water, and to remove some chemical contaminants. Most early designs were relatively small, producing less than 30,000 gallons per day of potable water, which is insufficient to support a small municipality. These systems fouled very quickly when turbid source water was encountered, and were not effective when attempting to treat waters contaminated with hydrocarbons or organic solvents. The most advanced systems currently available continue to experience fouling problems, and have limited ability to remove biological and chemical agents during extended deployments without including additional chemical cleaning systems.

As the need for transportable water purification evolved, systems capable of producing meaningful volumes of potable water (e.g., greater than 30,000 gallons per day) were eventually built into 40-foot long enclosed trailers for transport by trucks, or into 40-foot long ISO cargo containers for transport by truck, railroad, barge or ship. The weight of trailer-mounted systems was limited to the highway weight restriction of approximately 20,000 pounds, while cargo containers could weigh about 67,000 pounds. While such systems are “mobile”, they must be trucked to the site where water is needed. Accordingly, they can only be deployed at sites accessible by truck, and deployment must obviously await arrival of the truck. Both trailer-mounted water purification systems and 40-foot long ISO cargo container-based systems typically weigh far in excess of the 9,000 pound lifting capacity of a medium lift transport helicopter such as the Sikorsky UH-60 Black Hawk. Readily available commercial helicopters are typically limited to lifting a 20-foot long ISO cargo container at a gross weight of approximately 8,000 pounds.

Common source water contaminants include entrained large debris, small particle debris, suspended solids, salts, oils, volatile organic compounds (VOCs), naturally occurring heavy metals, and other chemicals, as well as living organisms and other pathogens. Available sources of raw water that may be drawn upon to produce safely-treated water may include some or all of such contaminants that must be removed prior to use. The substantial variation in the contaminants found in different water sources creates a challenge for designers of mobile water purification systems. If a purification system is designed to include treatment processes capable of removing only specific contaminants from source water, it cannot effectively treat water containing other types of contaminants. Even though a particular source of water may have historically contained only certain types of contaminants, natural or man-made disasters can suddenly introduce different types of contaminants into the source water. On the other hand, a more comprehensive purification system, designed to treat source water for the removal of all possible contaminants, can be considerably more costly to construct, operate and maintain than a system that treats only for contaminants actually present.

Portable water purification systems are needed for a wide variety of different scenarios and geographic locations, where the source water may be of unknown, or variable, quality. One of the greatest challenges encountered during the field operation or deployment of portable purification equipment is the ability to determine the primary contaminants within the source water, since this determines the requirements of the water purification process. This is particularly problematic during flood events in which the concentration and type of contaminants may change on an hourly basis.

Portable water purification systems commonly need to be deployed as part of a disaster relief response. For example, following Hurricane Katrina, conventional water treatment systems located in the New Orleans area, originally intended to treat fresh water from the Mississippi River or local lakes, were incapable of treating the contaminated mixture of fresh and salt water, debris, oil, and chemicals introduced into the source water supply. Similarly, when man-made chemicals or biological agents are suddenly introduced into domestic fresh water sources, a portable water purification system may be required to remove such chemical and/or biological agents. When source water is contaminated by microorganisms, industrial and agricultural pollutants and petroleum products, such substances cannot be filtered by the usual strainers and media type filters commonly found in municipal water treatment plants.

When relief efforts must be conducted following a catastrophe, such efforts are usually conducted under the supervision of governmental or military authorities. Apart from governmental and military use, private industries such as petroleum exploration, petroleum production, mining, and logging companies also need portable purification systems when deploying to remote areas lacking existing water treatment infrastructure in order to provide potable water for its personnel. Portable purification systems can also provide an effective source of potable water in underdeveloped countries lacking adequate water treatment infrastructure for their people.

Environmental factors must also be considered when configuring portable water purification systems. If such water purification equipment is needed in a remote area that is difficult to reach, it will likely be difficult to provide fuel needed to operate such equipment; it will also be more challenging to maintain and protect such equipment. The operator of such equipment may be faced with multiple demands of monitoring and maintaining the equipment, documenting its performance, changing operating parameters in view of changing raw water conditions, and documenting all of such activities per governmental agency requirements. The person charged with operating portable water purification equipment at a remote site will often lack the training or equipment needed to properly pre-screen the source water to determine the contaminants required for removal.

There has been fairly extensive evaluation of the performance of the US Army's “ROWPU” (reverse osmosis water purification unit). There have also been several iterations of this device with different flow rates. Despite several design changes, the “ROWPU” units remain plagued by fouling problems. Additionally, it has been recognized that for several contaminants of concern, reverse osmosis alone is not adequate to provide sufficient removal. All of the prior art mobile water purification systems, known to the present inventors, have some deficiency. Deficiencies exist in resistance to fouling, contaminant removal capability, potable water production capabilities versus physical size, ease of deployment, and operator intervention requirements.

While reverse osmosis units are highly-effective in removing salts, heavy metals, oils, pathogens and organic materials, reverse osmosis membranes also require significantly higher operating pressures to do their job. Such higher pressures typically mean that booster pumps must be provided to boost the pressure of the water being forced through such membranes. In turn, such booster pumps expend significant energy, drawing down on the available fuel source being used to power the portable water purification system. In addition, water treatment sources that use reverse osmosis units often result in production of purified water at slower flow rates as compared with water treatment systems that do not use reverse osmosis membranes. Thus, the use of reverse osmosis units under conditions when reverse osmosis is not truly required simply results in wasted energy and less flow.

When dealing with source water having unknown properties, there is a high potential for fouling water purification equipment. For example, it is likely that highly-turbid water will be encountered. Many known mobile water purification systems do not satisfactorily remove particulate matter before attempting to filter the water. For example, the industry standard practice is to pass raw water through a disposable 5 micron cartridge filter before sending the water through a reverse osmosis unit. However, disposable cartridge filters are quickly fouled, and require frequent changes by the operator. intervention requirements.

Standard commercially available reverse osmosis membranes have a very fine pore size of approximately 0.001 microns. However, much of the particulate matter present in raw water sources is much larger in size, ranging up to 5 microns, including most microorganisms, fine sand or silt, and colloidal matter. The presence of such larger particles is of particular concern for reverse osmosis systems operated at higher production rates (also referred to recovery rates). The larger particulates will foul the reverse osmosis membrane, and such foulant is often difficult to remove from the reverse osmosis membrane. Biofouling is well documented as a common fouling problem in reverse osmosis membrane systems, and such biological contaminants are particularly difficult to remove. If oil is present in the raw water source, the oil will readily foul reverse osmosis membrane surfaces. All prior art systems known to the inventors require operator intervention to clean such systems when such fouling occurs.

Apart from fouling problems, typical reverse osmosis membranes are easily damaged by free chlorine present in the water passed by such membranes. Normally, the raw source water does not include any significant amounts of free chlorine. However, it is known to add chlorine to backwash water used to periodically backwash ultrafiltration units that supply feed water to the reverse osmosis units. Chlorine is added to the backwash water to disinfect and/or prevent microbial growth within the ultrafiltration vessels. Following backwash, the ultrafiltration vessels are drained, but free chlorine may still be present within the ultrafiltration vessels. Upon return to the normal filtration cycle, water leaving the ultrafiltration vessels is pumped into the reverse osmosis units. Any free chlorine present in the water initially leaving the ultrafiltration vessels during a re-start of the filtration cycle following backwash is forced into the reverse osmosis units and can cause irreversible damage to the reverse osmosis membranes. Flushing the ultrafiltration vessels with water after backwash and draining, and before re-start, will usually avoid this problem, but requires a substantial volume of water that is effectively wasted. In addition, such a flushing cycle further prolongs the time delay between successive filtration cycles.

Many known portable water purification systems must be totally shut down in order to clean filtration systems when they become fouled. While one part of the water purification system may still be fully functional, that part sits idle while the operator cleans the portion of the water purification system that has become fouled. This practice results in water production becoming a start-stop procedure, rather than a continuous process. It can also lead to temporary shortages of usable water.

As already noted above, there are an abundance of contaminants that may be present in unknown source water, and which must be removed for the water to be safe for human consumption. Portable water purification systems deployed for disaster relief, emergency, or short-term seasonal events, must meet the same potable water quality standards and reporting requirements applied to permanent, stationary water treatment facilities. The US Environmental Protection Agency and the World Health Organization have established safety limits for many contaminants found in drinking water. Additionally, individual State agencies may impose regulatory limits regarding individual contaminants that are more stringent than Federal standards. Portable water purification equipment must be able to comply with such standards and limits in order to effectively and reliably produce potable water from the available source water.

Accordingly, it is an object of the present invention to provide a portable water purification system that can economically and efficiently produce meaningful volumes of potable water from impure or contaminated water in order to serve a municipality in the event of a natural or man-made disaster.

It is also an object of the present invention to provide a highly mobile water purification system that is configured of components that can easily be air-lifted to a site without the need to truck equipment to the site.

Another object of the present invention to provide such a mobile water purification system that is capable of removing virtually all types of contaminants likely to be found in a raw water source.

Still another object of the present invention is to provide a mobile water purification system that does not require highly-trained on-site operators, or off-site water quality laboratories, to assess the characteristics of the raw water source.

A further object of the present invention is to provide a mobile water purification system that can assists an operator in determining what contaminants within the raw water source need to be removed, and which further assists the operator to properly configure the purification system so that it can be placed into service as efficiently and as quickly as possible.

A still further object of the present invention is to provide such a mobile water purification system capable of automatically monitoring, reporting, and recording the quality of the raw water source and/or the quality of the potable water produced by the system.

Yet another object of the present invention is to provide a mobile water purification system capable of using reverse osmosis membranes when needed to remove contaminants that are otherwise difficult to filter out, while bypassing such reverse osmosis membranes when they are not required.

Still another object of the present invention is to provide a mobile water purification system in which organic matter is broken down before it reaches the filtration membranes to help prevent bio-fouling of such membranes.

A further object of the present invention is to provide a mobile water purification system that operates more continuously by maximizing the flow rate of processed water and minimizing total shutdowns of the system due to maintenance.

A yet further object of the present invention is to provide a mobile water purification system adapted to safely disinfect filtration membranes during backwashing while avoiding damage to downstream reverse osmosis units caused by the presence of free chlorine.

These and other objects of the invention will become more apparent to those skilled in the art as the description of the present invention proceeds.

### SUMMARY OF THE INVENTION

Briefly described, and in accordance with a preferred embodiment thereof, the present invention relates to a mobile water purification system configured of components, or modules, that can be readily airlifted to a site requiring potable water. A pump receives raw water from a raw water source and pumps it to a pre-treatment module. Ideally, the pump, which may be a screw-type pump, includes an inlet screen for preventing debris from entering the pump. The pre-treatment module preferably includes a separator, which may be a centrifugal-type separator, for removing suspended solids present in the raw water. Ideally, the pre-treatment module also includes a fine mesh screen downstream from the centrifugal separator for removing suspended solids of a predetermined size from the water flowing through the pre-treatment module before being discharged from the output port thereof.

In the preferred embodiment, the pre-treatment module also includes an advanced oxidation unit for oxidizing organic and inorganic contaminants present in the raw water. Hydrogen peroxide is preferably added to the water shortly before its passes through the oxidation unit to oxidize contaminants that may be present within such water. The oxidation unit may also include a source of ultraviolet light directed at water passing through the pre-treatment module to further enhance oxidation. The oxidation unit aids in neutralizing microorganisms, and reducing total organic carbons, originally present within the raw source water.

Water processed by the pre-treatment module is fed to one or more filtration modules, each having an input port coupled to the output port of the pre-treatment module. The filtration modules remove contaminants from the water passing therethrough, and discharge treated water to a storage tank. Each such filtration module may include a membrane filtration unit for removing bacteria, viruses, and suspended solids from the water passing therethrough. Ideally, each such filtration module includes an ultrafiltration unit for removing antibiotics, bacteria, viruses, suspended solids, organics and dyes from the water passing therethrough. Preferably, each such filtration module further includes a reverse osmosis unit that receives filtered water and removes ionic compounds and salts from the water passing therethrough. Chlorine may be added to water to be discharged from the filtration module.

Each of the filtration modules must periodically be backwashed to remove trapped contaminants. In order to minimize downtime while operating the mobile water purification system, a control system selectively operates valves to periodically backwash one filtration module while allowing one or more other filtration modules to operate normally. When a first filtration module is being backwashed, one valve couples pressurized backwash fluid to the first filtration module, and another valve couples the first filtration module to a drain to discharge trapped contaminants. After the first filtration module is returned to normal operation, a second filtration module is backwashed. During this second backwash cycle, another valve couples the pressurized backwash fluid to the second filtration module, and a still further valve couples the second filtration module to the drain. By staggering the first and second backwash cycles, the control system allows at least one of such filtration modules to be in an operative condition at all times. In the preferred embodiment, the mobile water purification system also includes a source of compressed air. Additional valves, selectively actuated by the control system, direct compressed air into each filtration module during its respective backwash cycle to help scrub solid contaminants collected therein.

While each filtration module preferably includes both a fine filtration unit and a reverse osmosis unit, reverse osmosis may not be required in many scenarios. Accordingly, valves are preferably provided, responsive to the aforementioned control system, for selectively bypassing the reverse osmosis unit if the contaminants within the raw water source do not require reverse osmosis. A first valve selectively couples the output of the fine filtration unit to the inlet of the reverse osmosis unit. A second valve selectively couples the outlet of the reverse osmosis unit to the storage tank to supply the permeate discharged by the reverse osmosis unit to the storage tank. A third valve selectively couples the outlet of the fine filtration unit directly to the storage tank while bypassing the reverse osmosis unit. The control system is coupled to the first, second, third valves to either bypass the reverse osmosis unit, or pass water through the reverse osmosis unit, depending upon the nature of the contaminants within the raw water source.

In an effort to help automate the mobile water purification system, one or more sensors may be incorporated within the water flow path at various points within the system to monitor water quality, contaminant levels, flow rate, pressure, pH, ORP (oxidation-reduction potential), temperature, TDS (total dissolved solids), suspended solids and turbidity. The control system may be responsive to one or more of such sensors for switching chemical feed pumps on or off; opening or closing valves; and turning pumps on or off. For example, in the preferred embodiment, a TDS sensor is inserted into the water flow path near the input port of the pre-treatment module for generating an electrical signal indicative of the relative TDS level within the raw water source; in this regard, the TDS sensor might simply indicate whether the level of total dissolved solids within the raw water is above or below a predetermined level. The control system is responsive to the electrical signal generated by the TDS sensor for alternately passing water through the reverse osmosis unit, or bypassing, the reverse osmosis unit and disabling its booster pumps, during processing of such raw water. As noted earlier, the control system is operatively coupled to valves which either direct water through the booster pump and reverse osmosis unit, or direct water around the booster pump and reverse osmosis unit.

It will be recalled that reverse osmosis membranes can be irreparably damaged if free chlorine is circulated therethrough. The present invention further provides a method of operating a water purification system that significantly reduces the risk of such damage. Raw water is pumped from a raw water source to a filtration module. Within the filtrations module, water is passed through a fine filtration unit during a series of filtering cycles to trap contaminants, and to discharge filtered water. The filtered water discharged from the fine filtration unit is passed through a reverse osmosis unit to further remove contaminants from water passing therethrough; clean water (permeate) is discharged from the reverse osmosis unit. A source of backwash fluid is provided; chlorine is added to the backwash fluid to disinfect the fine filtration unit during the backwash cycle. Periodically, the fine filtration unit is backwashed with chlorinated backwash fluid during a backwash cycle, which occurs between successive filtering cycles, to flush trapped contaminants from the fine filtration unit to waste. Preferably, compressed air is directed into the fine filtration unit during the backwash cycle to aid in removing suspended solids from the fine filtration unit. Backwash fluid is then drained from the fine filtration unit. The fine filtration unit is then re-filled with fill water and sodium bisulfite to refill the fine filtration unit while simultaneously neutralizing any remaining free chlorine left within the fine filtration unit by the backwash fluid. The next successive filtering cycle is then initiated.

### BRIEF DESCRIPTION OF THE DRAWINGS

FIG. 1 is a perspective view of a helicopter delivering a pre-treatment module (PTM) to a site requiring water purification.

FIG. 2 is a perspective view of the site shown in FIG. 1 after all basic modules have been delivered but before they are interconnected.

FIG. 3 is a perspective view of the components shown in FIG. 2 after being interconnected with each other, with a source of raw water, and with a purified water delivery line.

FIG. 4 is a perspective view of an alternate embodiment wherein a single PTM supplies pre-treated water to three ultrafiltration modules.

FIG. 5 is a perspective view of the exterior of the PTM.

FIG. 6 is a perspective view of the interior of the PTM, including a control center for seating an operator.

FIG. 7 is a schematic flow diagram showing the flow of water into, and out of, the PTM.

FIG. 8 is a perspective, sectional view of the interior of the ultrafiltration module showing a series of hollow fiber ultrafiltration membrane units extending vertically, parallel to each other, along the rear wall of the ultrafiltration module.

FIG. 9 is a perspective, sectional view of the interior of the ultrafiltration module showing a series of horizontally-extending reverse osmosis units disposed ahead of the membrane units shown in FIG. 8.

FIG. 10 is a schematic flow diagram showing the flow of water into, and out of, the ultrafiltration module.

FIG. 11 is a schematic flow diagram showing a membrane filter, and associated valving, during a normal filtration cycle.

FIG. 12 is a schematic flow diagram showing the membrane filter of FIG. 11, and associated valving, during a backwash cycle.

### DETAILED DESCRIPTION OF THE PREFERRED EMBODIMENTS

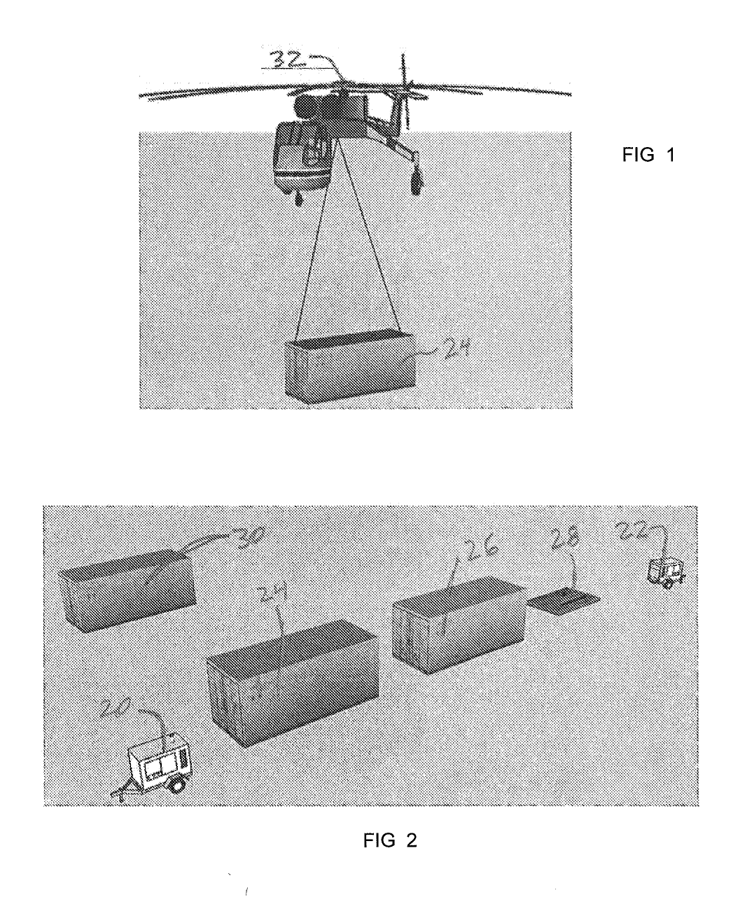

Referring to FIG. 2, the components of a mobile water purification system in accordance with a preferred embodiment of the present invention are illustrated. As shown in FIG. 2, the basic components of the mobile water purification system include a raw water pumping unit 20; a second pumping unit 22 to deliver treated water for distribution to users; a pre-treatment module (or “PTM”) 24; a filtration module 26; a bladder storage tank 28; and a filter support module 30.

The PTM 24, filtration module 26, and filter support module 30 may each be formed from a conventional 8-foot wide×8-foot tall×20-foot long ISO shipping container, preferably made of aluminum or a composite material to minimize weight. Each of these components weighs less than 8,000 pounds, and may be delivered to the site by a medium lift transport helicopter 32 such as the Sikorsky UH-60 Black Hawk, as shown in FIG. 1. The same helicopter may be used to deliver raw water pumping unit 20 and treated water pumping unit 22.

Raw water pumping unit 20 is preferably a positive displacement style pump of the type commercially available under the brand name “ScrewSucker” from APSCO, Inc. of Kirkland, Wash. Such pumps can be obtained either on a self-contained skid or on a wheeled trailer, are driven by a diesel engine, are based upon a Hidrostal screw-type centrifugal pump design, and provide a raw water feed flow of between 80-400 gallons per minute, depending upon the nature of the raw water being pumped, the sizing of the diameter of the hoses (three inch or four inch) connected thereto, and the number of filtration modules 26 in service. Treated water pumping unit 22 may be of the same type used for raw water pumping unit 20, and is capable of providing 100 gallons of treated water per minute at over 85 psi discharge pressure.

Bladder storage tank 28 has a preferred capacity of 10,000 gallons. Such pillow-type bladder storage tanks are commercially available in sizes ranging well over 200,000 gallons. The size and weight of bladder tank 28 is directly related to its capacity. For example, a 25,000 gallon capacity bladder is approximately 37 feet long×35 feet wide×5.25 feet tall, with an empty weight of about 750 pounds.

Filter support module 30 contains a 50 Kw diesel generator for providing electrical power needed by PTM 24 and filtration module 26; the most significant electrical power requirements are imposed by the reverse osmosis equipment within filtration module 26, particularly when processing seawater. Filter support module 30 may also be used to contain bladder storage tank 28, as well as required pumping hoses, during transport to the site.

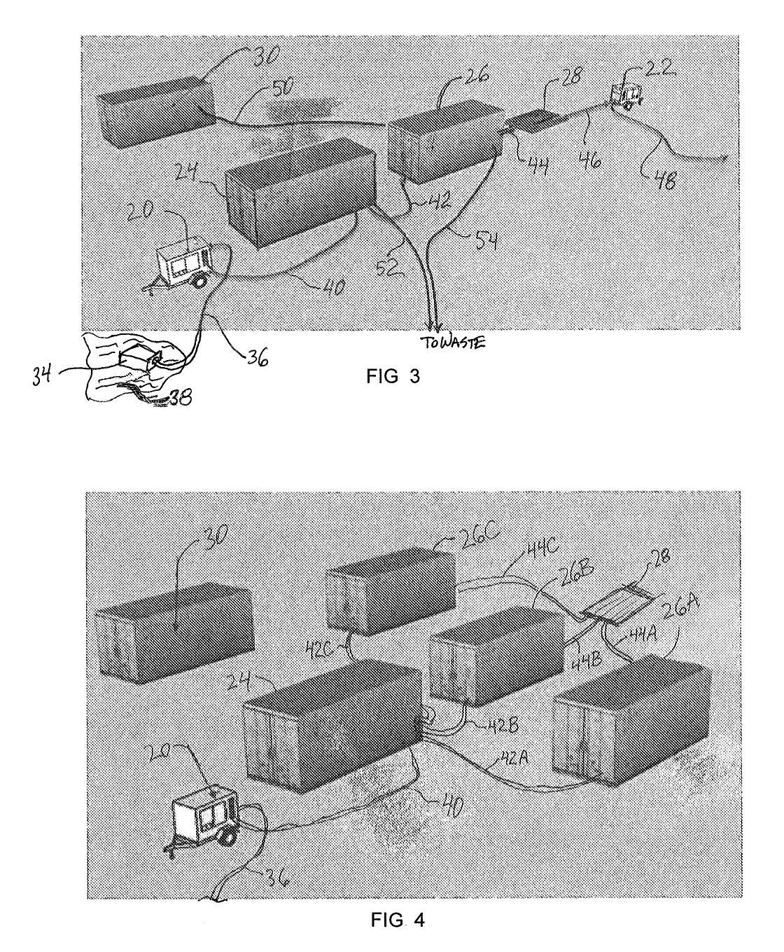

Turning to FIG. 3, the mobile water purification system is shown after related hoses and electrical cabling has been installed. Raw water inlet hose 36 extends from a floating strainer 34 disposed within the source of raw water, for example, lake 38. Floating strainer 34 may be of the type commercially available under the brand name “Float Dock” from Fol-Da-Tank of Milan, Ill. Hose 36 is preferably a 3-inch diameter industrial pump suction hose. The opposite end of hose 36 is coupled to the inlet of raw water pumping unit 20. The output port of raw water pumping unit 20 is coupled by hose 40 to the input port of PTM 24. Those skilled in the art will understand that, while only one PTM 24 is illustrated, two or more pre-treatment modules could be provided at the site if desired to boost the capacity of the water purification system.

Still referring to FIG. 3, hose 42 couples the output port of PTM 24 to the input port of filtration module 26. Fully-treated water discharged by filtration module 26 is coupled by hose 44 to the inlet of storage bladder tank 28. The outlet of storage bladder tank 28 is coupled by hose 46 to the inlet of treated water pumping unit 22. Finally, the output port of pumping unit 22 is coupled by hose 48 to a municipal water supply distribution system or the like.

As noted above, filter support module 30 includes a diesel generator for supplying electrical power. Electrical cable 50 extends from filter support module 30 to filtration module 26 to supply electrical power thereto. As will be described in greater detail below, PTM 24 may include its own smaller electrical generator, in which case, PTM 24 need not share electrical power provided by filter support module 30. If PTM 24 is not provided with its own electrical generator, then a further electrical cable (not shown) may be extended from filter support module 30 to PTM 24. If the site requiring fresh water already has a reliable source of electrical power, then filter support module 30 is not required at the site.

As mentioned above, various separators and filtration membranes provided within PTM 24 and filtration module 26 must periodically be flushed and/or backwashed to purge contaminants therefrom. Accordingly, a first drain hose 52 extends from PTM 24, and a second drain hose 54 extends from filtration module 26, to carry away contaminants trapped thereby to waste. Depending upon the circumstances, the contaminants drained by hoses 52 and 54 may be stored at the site for later removal, or may be re-introduced into raw water source 38.

FIG. 3 illustrates only a single filtration module 26. Those skilled in the art will appreciate, however, that two or more filtration modules may be provided, if desired. As illustrated in FIG. 4. PTM 24 is supplied with raw water by pumping unit 20 via hose 40, as in FIG. 3. However, in FIG. 4, three filtration modules 26A, 26B, and 26C all receive pre-treated water from PTM 24 via hoses 42A, 42B and 42C, respectively. Within FIG. 4, electrical cabling and drain lines have been omitted for clarity of illustration. Each of filtration modules 26A, 26B, and 26C has its output port coupled to storage bladder tank 28 via hoses 44A, 44B, and 44C, respectively. Clearly, providing two or more filtration modules 26 can increase the rate at which clean water can be produced as compared with a single filtration module. However, a further benefit of providing two or more filtration modules 26 is that the process of producing clean water need not be stopped merely because one of such filtration modules 26 needs to be backwashed, as will be further explained below. Once continuous flow is established through PTM 24 and a first filtration module (26A), additional filtration modules (26B, 26C) can be added and later removed to adjust total output capacity without requiring shutdown or disassembly of the entire system.

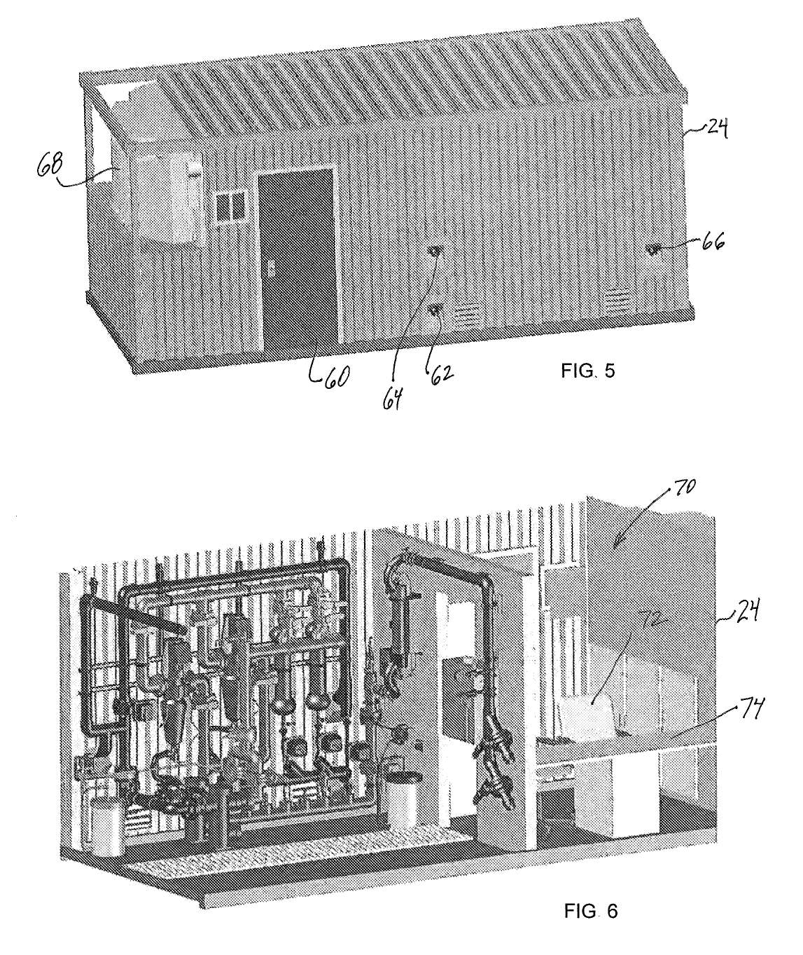

FIG. 5 shows the exterior of PTM 24. PTM 24 houses both purification equipment and a small office for an on-site operator. Accordingly, an entry door 60 is provided to allow the operator to access the interior. Input, output, and drain fittings 62, 64, and 66 are provided in the side wall of PTM 24 for coupling to the ends of hoses 40, 42 and 52 (see FIG. 3). Also shown in FIG. 5 is an optional 15 Kw “clip-on” style diesel generator 68 for generating electrical power used by PTM 24. Generator 68 may be of the type commercially available from Carrier Corporation of Syracuse, N.Y. under the brand name “PowerLINE RG15”.

FIG. 6 shows the interior of PTM 24. A small office area 70 is provided with chair 72 and desk 74 for the onsite operator. Not shown is a programmable logic controller (PLC) computer used by the operator to allow the operator to monitor and control the operation of PTM 24. The PLCs used to control the functions of PTM 24 and filtration module 26 are preferably of the type supplied by Rockwell Automation, Inc. under the Allen Bradley CompactLogix brand, which includes a color touchscreen graphic terminal panel to display information to the operator, and to receive operator commands. Once initialized, this control computer guides the operator through the setup and startup of the entire purification system from setting the floating intake 34 in the source water 38 to connecting the treated water discharge pump 22 to the community water supply. The larger portion of PTM 24 houses the actual components used to remove suspended solids from the incoming raw water. Filtration module 26 likewise includes a PLC for controlling the operation of the ultrafiltration units and reverse osmosis units contained therein. The PLC in PTM 24 serves as the “master”; the PLCs in the filtration modules 26 communicate with the master PLC in PTM 24 by wireless connections. Each PLC communicates with the devices that it senses or controls via an Ethernet Industrial Protocol communications platform. Performance data collected by the PLC in PTM 24 can be stored and transmitted to remote offices via a cellular modem over a cellular phone system for analysis.

Suspended solids are particles that are not dissolved in the water and can be physically removed by the purification process. The amount of suspended solids in the water is generally determined by its source, i.e., lake, river, pond, etc., and is influenced by a number of factors. The flow rate of the water body is a primary factor, as fast running water can carry more and larger-sized particles. Heavy rains create flooding that carry trash, soil, and organic particles (such as leaves, soil, and animal waste) to surface waters. Traditional municipal water treatment plants use coagulation, flocculation, and sedimentation to remove suspended solids, often adding chemicals such as metal salts or organic polymers to assist in such removal. However, this process requires long detention times and relatively large settling ponds, neither of which is suitable for a mobile water purification system.

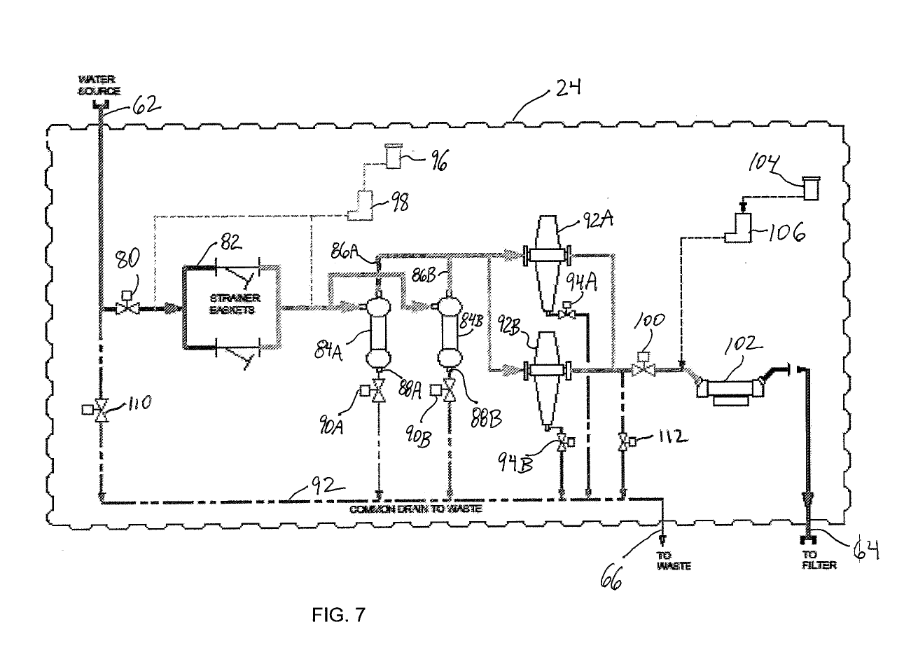

Referring jointly to FIGS. 6 and 7, PTM 24 receives incoming raw water at input port 62. Inlet flow control valve 80 selectively directs such water to strainer baskets 82 for removing large debris such as sticks, leaves, trash, and aquatic creatures that might interfere with downstream process steps. The simplest way for removal of large, visible objects is a simple basket strainer, such as the Hayward-brand SB Series Simplex basket strainer available from Hayward Industries, Inc. of Clemmons, N.C. These strainers use a stainless steel perforated basket, thereby eliminating the need to continually replace bag-type filters. Pressure gauges located on the upstream and downstream piping connected to such basket strainers are used to determine the differential pressure across the strainers, which is an indication of when the basket needs to be removed for cleaning.

Water exiting strainer baskets 80 is sent to centrifugal separators 84A and 84B. Centrifugal separators 84A and 84B, also known as “cyclone separators”, do the bulk of the work in separating and removing suspended particles. Centrifugal separators 84A and 84B may be of the type commercially available from Lakos of Fresno, Calif. as “ILB Centrigugal-Action Separators”. Centrifugal separators have no moving parts, and do not require maintenance. Feed water enters each separator tangentially through an inlet in the upper chamber of the unit. The inlet's position immediately creates a strong centrifugal force on the suspended solids contained in the feed water. The water is forced downward along the outer circumference of the separator's mid-section, accelerating and separating heavier particles from the water. Solids are collected in the lower chamber, and clean water flows upward through a center pipe where it discharges from the top of each unit through pipes 86A and 86B. Captured solids are discharged to waste through outlets 88A and 88B on the lower chamber of each separator. Waste valves 90A and 90B are electrically operated ball valves that are opened periodically by a control system based upon assessed raw water quality. Flow need not be stopped during purging of separators 84A and 84B; i.e., raw incoming water continues to flow into, and out of pipes 86A and 86B, even when waste valves 90A and 90B are temporarily opened. Trapped solids purged from separators 84A and 84B are routed to common waste line 92 and directed to drain port 66 on the side wall of PTM 24. When operated within the separator's designed flow range (65-108 gallons per minute), the technology is capable of removing up to 98% of particles larger than 74 microns.

Discharge pipes 86A and 86B send partially cleaned water to fine particle removal filters 92A and 92B. These fine particle filters may be of the type commercially available from Amiad Water Systems of Mooresville, N.C. under Model No. TAF-750. Under normal operating conditions, at least 95% of the suspended solids contained in the feed water will have been removed by centrifugal separators 84A and 84B. The suspended solids remaining in the feed water will generally be less than 200 microns in size and are the most difficult to remove.

The Amiad TAF-750 filter is a 3″ automatic, self-cleaning filter having an internal fine mesh stainless steel filter that is field replaceable. These fine mesh stainless steel filters are available in mesh sizes that range between 500 microns and 10 microns. In the preferred embodiment, a 100 micron screen is used to provide a balance between the degree of filtration while avoiding shorter operating cycles and reduced flow capacity associated with smaller screen sizes. Feed water enters the inner area of the internal screen cylinder and flows through the screen to the filter outlet. Suspended solids are trapped on the inner screen surface and form a “filtration cake” that causes a differential pressure across the screen capturing particles that would otherwise pass through the screen opening.

Filters 92A and 92B are equipped with an integral control module that monitors pressure drop across such filters. A pressure differential switch contained in the control module monitors the pressure differential across the screen (inlet and outlet water pressure) and sends a signal to the controller when it reaches a pre-set, field adjustable value, usually 7 psi. The filter then begins the self-cleaning process, while filtered water continues to flow through the unit. Solenoid-actuated exhaust valves 94A and 94B at the end of each filter body are opened by their respective controllers during such self-cleaning process. An electronically driven suction nozzle rotates across the inner surface of the screen, and forces the captured filtration cake out the exhaust valve to common waste line 92. These self-cleaning cycles can be completed in 16 seconds using less than 7 gallons of water, while allowing continuous flow through filters 92A and 92B. Each of filters 92A and 92B can filter as much as 80 gallons of feed water per minute. The reduction in this remaining portion of suspended solids greatly enhances the performance of the downstream advanced oxidation and ultrafiltration systems.

If desired, a chemical coagulant can be added to the feed water to aid in coagulating solid particles for more effective removal. Examples of primary coagulants are metallic salts, such as aluminum sulfate (referred to as alum), ferric sulfate, and ferric chloride. Cationic polymers may also be used as primary coagulants. Organic polymers, such as polyaluminum hydroxychloride (PACO, are typically used to enhance coagulation in combination with a primary coagulant. The advantage of these organic polymers is that they have a high positive charge and are much more effective at small dosages. As shown in FIG. 7, a coagulant polymer reservoir 96 is coupled to metering pump 98 for adding the coagulant polymer to the feed water, either before, or after, strainer baskets 82. Metering pump 98 may be a peristaltic pump of the type commercially available from Thermo Fisher Scientific Inc. of Waltham, Mass. under the brand name “Masterflex”. Metering pump 98 is remotely started and stopped through the by the same control system used to control the aforementioned valves.

Still referring to FIG. 7, filtered water discharged from fine particle filters 92A and 92B passes through filter module feed valve 100 and into UV advanced oxidation unit 102. Oxidation unit 102 is preferably an in-line UV system of the type commercially available from Neotech Aqua Solutions, Inc. of San Diego, Calif. under Model No. D428, designed to handle flow rates of 226 gallons per minute or more. Advanced oxidation unit 102 preferably uses both ultraviolet light and hydrogen peroxide to oxidize and destroy organic and/or biological contaminants. The hydrogen peroxide flow rate and the ultraviolet light dosing rate can be adjusted to ensure removal of specific organic and/or inorganic contaminants known to exist in the flow stream.

Advanced Oxidation Processes (“AOPs”) are a set of chemical treatment procedures designed to remove organic and/or inorganic materials in water by oxidation through reactions with hydroxyl radicals (OH—). This term usually refers more specifically to a subset of chemical processes that employ a combination of ozone (O₃), hydrogen peroxide (H₂O₂) and/or UV light. AOPs offer several advantages in water treatment that other technologies cannot achieve. For example, peroxide/UV AOPs have been proven to destroy carcinogenic organic contaminants such as PCE, MTBE, NDMA, benzene and other VOCs directly in the water through chemical transformation. Similarly, AOPs can remove biologically toxic or non-degradable materials such as BOD, COD, pesticides, herbicides, and petroleum constituents including soluble hydrocarbons from oilfield-produced water. In addition, AOPs are believed to be capable of removing unregulated organic compounds such as endocrine disruptors and other pharmaceuticals, as well as biological threats such as legionella, anthrax, and botulism. As biological microorganisms absorb ultraviolet radiation, a photochemical reaction occurs that alters molecular components essential to cell function. As UV rays penetrate the cell wall of the microorganism, the energy reacts with nucleic acids and other vital cell components, resulting in injury or death of the exposed cells.

As shown in FIG. 7, hydrogen peroxide is preferably stored in reservoir 104 within PTM 24, and is pumped through metering pump 106 into the flow of filtered water just before it enters oxidation unit 102. Metering pump 106 is remotely started and stopped through the by the same control system used to control the aforementioned valves. The addition of hydrogen peroxide directly upstream of the UV chamber in oxidation unit 102 significantly enhances the effectiveness of UV radiation. Water exiting advanced oxidation unit 102 is directed to hose fitting 64 on the side wall of PTM 24 for delivery to filtration module 26. Hydroxyl radicals from the hydrogen peroxide help to completely oxidize dissolved organic contaminants in aqueous media and produce carbon dioxide, water and salts as by-products. In addition, any excess coagulant polymer applied for suspended solids removal which remains in the flow stream will be eliminated by the UV oxidation unit 102 so as not to affect performance of the downstream membrane filter systems.

It should be noted that, in water treatment systems disclosed in the past, such advanced oxidation is usually performed as the last step in the water treatment process, i.e, after ultrafiltration and after passage through a reverse osmosis membrane. Flood waters will inherently contain a much greater biological population than typically encountered under normal source water conditions. This biological population includes fine organic particles and debris, algae, bacteria, viruses, and e-coli. These components present significant problems throughout the filtration process, ranging from membrane fouling to an increase in biological fouling of filter elements. On the other hand, by carrying out the AOP process prior to ultrafiltration, the biological population can be significantly reduced within the flow stream sent on to the ultrafiltration unit, thereby increasing the efficiency of the downstream membrane filtration processes.

Upon initial start-up of PTM 24, inlet flow control valve 80 is initially closed, blocking feed water from entering strainer baskets 82. Instead, an inlet bypass valve 110 is open, directing incoming raw water to drain line 92. Pretreatment diverter valve 112 is initially open, while filter module feed valve 100 is initially closed. As feed flow reaches PTM 24, a flow switch (not shown) in the drain line senses flow to the system; this causes a window to be displayed to the operator on the operator's control display asking the operator whether pretreatment should commence. Upon acknowledgment by the operator, pretreatment diverter valve 112 modulates to a closed position, while inlet flow control valve 80 opens to direct flow through the system. It will be noted that inlet bypass valve 110 modulates to control the flow rate through PTM 24, allowing for use of any pressurized feed water of sufficient volume, thereby allowing for easy integration with existing pumping facilities. Bypass valve 110 is controlled by the programmable logic controller (PLC) to provide feed flow based upon the number of filtration modules (26A, 26B, 26C) coupled to the output port of PTM 24. Bypass valve 110 can be modulated toward a closed position to increase the pressure of water discharged from PTM 24, if necessary, to maintain at least a minimum water pressure to one or more filtration modules connected thereto.

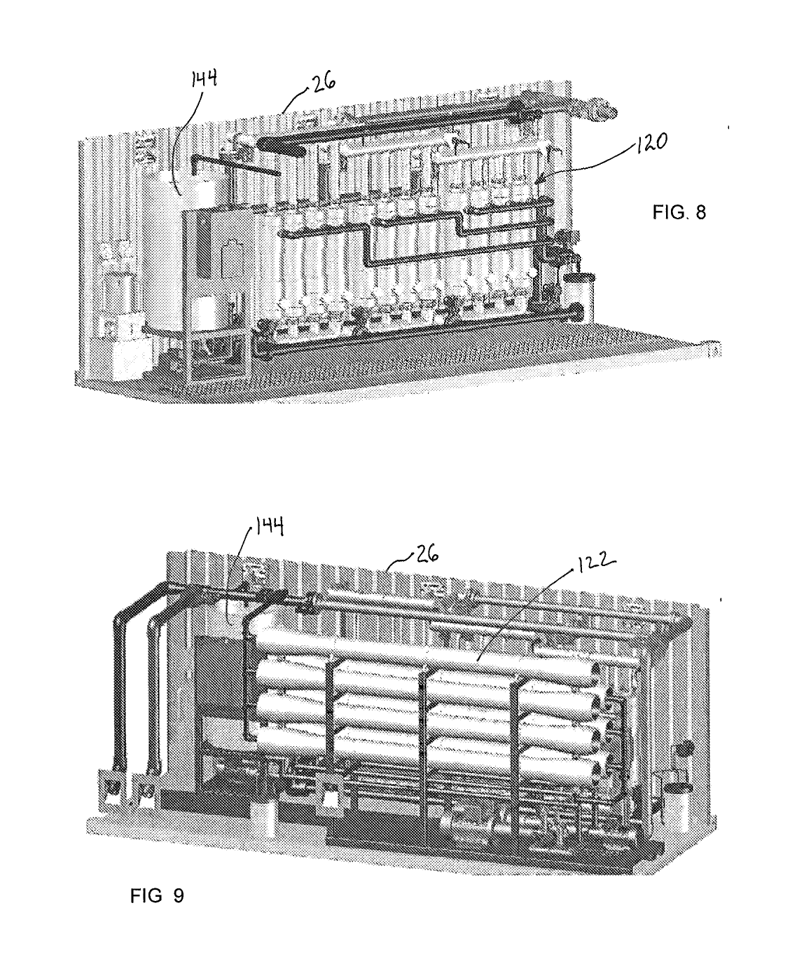

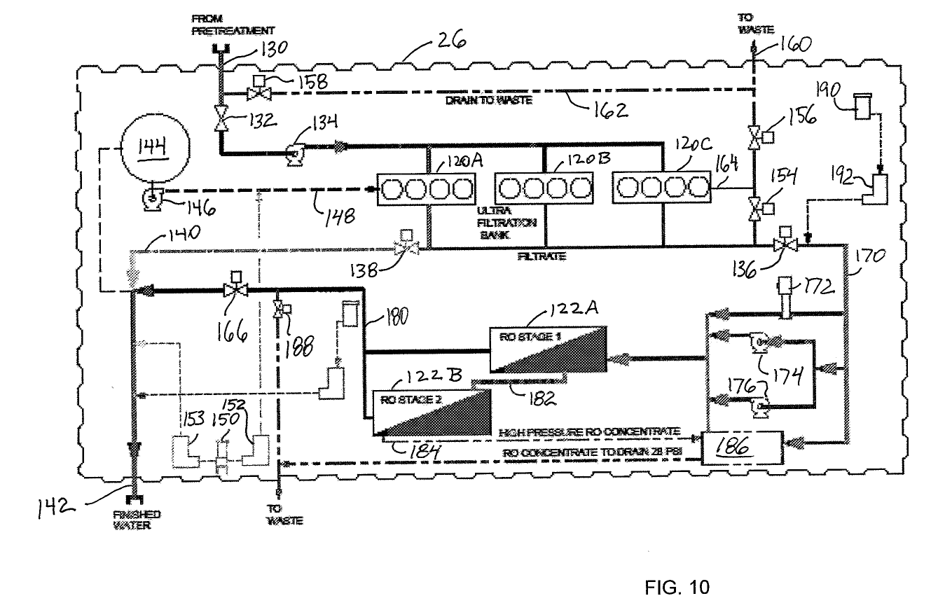

FIGS. 8 and 9 illustrate different sections of filtration module 56, while FIG. 10 schematically illustrates how water flows through filtration module 56. FIG. 8 shows a series of hollow fiber ultrafiltration membrane units 120 extending vertically, parallel to each other, along the rear wall of ultrafiltration module 26. In FIG. 9, a series of horizontally-extending reverse osmosis units 122 are shown in the foreground (membrane units 120 are shown in the background in FIG. 8). PTM 24 is designed to remove suspended solids larger than 100 microns in size, and turbidity to 20 ntu or less, before the feed water is passed along to filtration module 26. Feed water entering into filtration module 26 will contain varying concentrations of fine particulates not captured during the suspended solids removal process carried out by PTM 24. These remaining fine particles are then removed by filtration module 26 using a hollow fiber ultrafiltration system capable of handling high turbidity waters.

Referring to FIG. 10, water discharged by PTM 24 is received at input port 130. Initially, valve 132 is closed and pneumatically-controlled bypass valve 158 is open, thereby initially directing incoming feed water to waste port. One or more sensors (total dissolved solids, pH, etc.) may be located within bypass line to confirm the quality of the feed water entering filtration module 26 before it is placed into service. Assuming that the feed water quality level is satisfactory, the operator partially opens manual feed valve 132 to slowly fill ultrafiltration vessels 120A, 120B, and 120C. As manual feed valve 132 is opened, bypass valve 158 modulates closed to maintain the inlet pressure of the incoming feed water.

Initially, valves 138 and 136 are closed, while valves 154 and 156 are open, and fill water introduced into ultrafiltration banks 120A, 120B and 120C begins to flow through valves 154 and 156 to waste port 160; a flow switch (not shown) at the outlet of valve 156 indicates that the into ultrafiltration banks 120A, 120B and 120C have filled. A window is displayed to the operator on the control system monitor indicating that ultrafiltration banks 120A, 120B and 120C have filled, and asking the operator to confirm that operation of the ultrafiltration system should begin. The operator then completely opens feed valve 132, and bypass valve 158 fully closes. At the computer, the operator also acknowledges that ultrafiltration should begin; the control system then actuates ultrafiltration booster pump 134. The ultrafiltration operation now begins, with the filtrate initially flowing to waste through opened valves 154 and 156. The speed of booster pump 134 is adjusted to maintain an 80 gallon per minute flow rate through the system. Preferably, pump 134 is a variable-frequency-drive (VFD) pump of the type commercially available from Grundfos Pumps Corporation of Olathe, Kans. under Model No. CM15-2. A VFD-style pump is preferably used to increase feed pressure as the flow rate through the ultrafiltration membranes decline during the filtration cycle, thus maintaining a constant filtrate output rate.

Ultrafiltration banks 120A, 120B and 120C are preferably of the hollow fiber ultrafiltration membrane type commercially available from Toray Membrane USA, Inc. of Poway, California under the brand name “TORAYFIL”, module No. HFU-1020N, which contains 312 square feet of membrane surface area with a nominal pore size of 0.02 microns. The membrane is housed in a 8.5″ diameter×3.625′ long PVC pressure vessel weighing 88 pounds. Hollow fiber micro and ultrafiltration systems are traditionally mounted vertically and operated in what is referred to as a “dead end” mode, wherein the filtrate enters the fibers and exits through the top of the filter housing. Clean water passes through the wall of the membrane fibers as the feed water travels upward through the vessel. The Toray filter element operates under an outside-to-inside filtration flow direction within a PVC filter housing, or pressure vessel. During the filtration cycle, suspended solids are trapped on the exterior of the fibers, and as they build up, the operating pressure increases. The vessels are then automatically backwashed and air-scoured by pressurized air, to remove the particulate matter. The vertical mounting orientation is used due to the need to air-scour and clean the vessel.

Hollow fiber membrane systems are designed to operate under predetermined filter and backwash cycles. The length of the filter cycle is adjusted based on the concentration of suspended solids in the feed water. The filter cycle duration ranges from 20 to 60 minutes, with a manufacturer-recommended filter cycle of 30 minutes. The filtration cycle may also be shortened or lengthened based on the quality of the feed water, concentrating the majority of the feed water's suspended solids in the upper end of the pressure vessel. The retained solids on the membrane surface will cause the membrane's flux rate (production) to continue to decline unless the feed water pressure is increased.

Each of the UF banks 120A, 120B and 120C is equipped with a backwash outlet vent; for example, in FIG. 10, UF bank 120C has its backwash outlet vent coupled by pipe 164 to the drain line extending between valves 154 and 156. Each such backwash outlet vent is used to create a small waste stream from the upper portion of its respective pressure vessel. This small waste stream continuously removes a portion of the trapped solids from its associated pressure vessel, which is discharged through the UF drain line 162 to waste port 160. A rotometer may be used to adjust the wasting rate, which is increased as the turbidity of the feed water increases. This small waste stream extends the duration of the filtration cycle between backwash cycles. On the other hand, the backwash outlet vent may be closed altogether to maximize the UF system production when high quality feed water is available.

The ultrafiltration system includes a total of twelve of such vessels mounted as a single-row assembly along the rear exterior wall of the shipping container 26. The twelve UF vessels are preferably grouped into three independent modules of four vessels each, providing ultrafiltration banks 120A, 120B and 120C. One of the advantages of providing the UF vessels in three separate banks is that two of such banks (e.g., 120A and 120B) can remain in continuous service while a third bank (e.g., 120C) is backwashed, so filtrate production is not interrupted. When one such bank is being backwashed, the flow rate through the other two UF banks in service is increased for about three minutes while the third UF bank is being backwashed. Also, by separating the ultrafiltration module into three separate banks and staggering the backwash cycle for those three banks, the volume of backwash water and compressed air required for each individual backwash cycle is reduced to one-third of that required if all of such UF vessels were backwashed simultaneously, thereby reducing the size, horsepower, and associated electrical load of the backwash supply pump and air compressor.

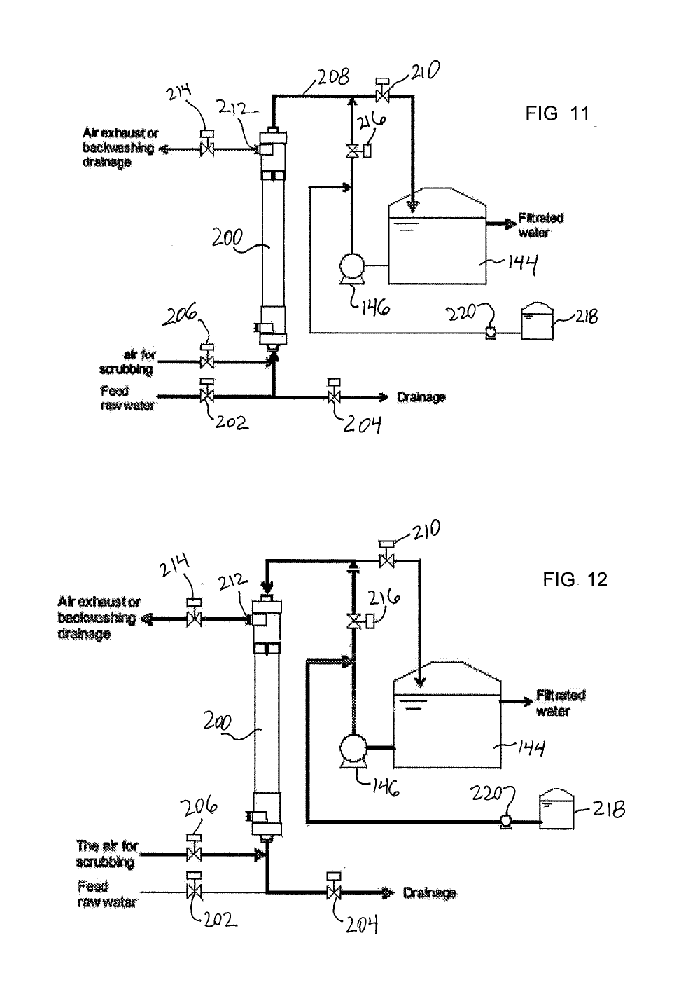

Backwash tank 144 is a small polyethylene tank installed within filtration module 26 and stores a supply of backwash water. Backwash tank 144 preferably includes a float valve (not shown) to maintain the water level in tank 144 by selectively admitting treated water from treated water discharge line 140. This arrangement provides high quality filtrate or RO permeate that enhances the cleaning efficiency of the UF backwash cycle. Backwash pump 146 is selectively actuated to pump backwash fluid along line 148 to one of the three banks of ultrafiltration units 120A, 120B, or 120C. During the time when backwash fluid from tank 144 is being pumped into one of ultrafiltration banks 120A, 120B, or 120C, free chlorine is added to disinfect such ultrafiltration bank. Reservoir 150 stores chlorine (e.g., as sodium hypochlorite in liquid form, or as solid calcium hypochlorite in tablet form). A first feed pump 152 is actuated during the initial backwash cycle to add chlorine to the backwash water pumped into the ultrafiltration vessels. It should be noted that pump 152 is disabled when the filtration vessels are re-filled after being drained. A second feed pump 153 can be provided to add chlorine to the treated water just before it is discharged from port 142. A further description of the backwash cycle of UF banks 120A, 120B and 120C is provided below in conjunction with FIGS. 11 and 12.

Continuing with the description of FIG. 10, valves 136 and 138 provide the option of employing reverse osmosis to remove dissolved contaminants, or bypassing the reverse osmosis operation. If, due to the nature of the raw source water, reverse osmosis is not required, a window is displayed on the operator's control monitor asking for permission to bypass reverse osmosis, and to direct the filtrate produced by UF banks 120A, 120B and 120C to finished water port 142 through valve 138. Upon receiving an acknowledgment from the operator, the control system signals reverse osmosis feed valve 136 to close, signals reverse osmosis bypass valve 138 to open, and signals reverse osmosis outlet valve 166 to close, thereby sending UF filtrate directly to finished water port 142, and bypassing reverse osmosis. The control system then begins data collection of treated water discharged by finished water port 142 to storage bladder 28.

On the other hand, if reverse osmosis is required due to contaminants dissolved in the feed water, then reverse osmosis feed valve is opened, reverse osmosis bypass valve 138 is closed, and the reverse osmosis system begins filling with feed water. As shown in FIG. 10, reverse osmosis feed line 170 is coupled to the inlet of a low pressure feed pump 172, coupled to the inlet of a first high-pressure feed pump 174, and also coupled the inlet of a second high-pressure feed pump 176. The initial filling operation can be initially controlled using manual valves already provided on the reverse osmosis units.

Booster pumps 172, 174 and 176 are designed to optimize the efficiency of supplying feed water to the reverse osmosis unit while minimizing the electrical load required. If the total dissolved solids (TDS) is relatively low (e.g., a fresh water source having TDS <2,000 mg/l), then a low pressure, multi-stage centrifugal pump with variable-frequency-drive (VFD) is sufficient, for example, a Grundfos/Goulds brand low pressure feed pump of the type sold as Model No. CRI 15-11. In this scenario, low pressure booster pump 172 is all that is required. On the other hand, if the raw water source is seawater (wherein TDS will likely range from 28,000 to 35,000 mg/l), then booster pumping is performed by two Danfoss APP positive displacement pumps 174 and 176 available from Danfoss North America under Model No. APP-8.2. In this case, each of the high-pressure pumps is sized for one-half the total feed flow rate); one of such high-pressure pumps is operated as a constant speed unit, while the other is controlled using variable-frequency-drive (VFD) to allow for adjustment of system pressure. In some cases, the raw water source will be from a high salinity source (i.e., TDS in the range of 35,000 to 50,000 mg/l); in this case, high-pressure pumps 174 and 176 are preferably operated with an energy recovery device (ERD) performed using a Danfoss iSave unit, such as Model No. Isave 21 commercially available from Danfoss North America.

As shown in FIG. 10, the reverse osmosis filtration system is preferably a two stage configuration, wherein filtered water is initially coupled to the feed inlet of first stage 122A. The clean effluent, or permeate, produced by first stage 122A is passed to RO effluent discharge line 180. The concentrate produced by first stage 122A is then passed by concentrate line 182 to the feed inlet of second stage 122B. The permeate produced by second stage 122B is also passed to RO effluent discharge line 180. The high-pressure concentrate discharged by second stage 122B is conveyed by RO concentrate line to an optional energy recovery device (ERD) 186 integrated with high-pressure booster pumps 174 and 176, or simply discharged to waste.

Once flow through the RO system is established, the unit is operated to waste (i.e., RO effluent valve 166 is closed, and the RO filter-to-waste valve 188 is opened for at least 30 minutes to remove all preservative from the RO elements and allow the operator to verify permeate TDS concentration is in accordance with performance projections for the available source water. When the operator confirms that the RO system is ready to be placed into service, the RO effluent valve 166 is opened, and RO filter-to-waste valve 188 is closed. Clean permeate from the reverse osmosis unit is then supplied to finished water port 142, and the control system again begins data collection of treated water discharged by finished water port 142 to storage bladder 28.

First and second reverse osmosis stages 122A and 122B each contain three membrane elements per pressure vessel housing, with 400 square feet of membrane per element. The minimum concentrate flow through the membranes is maintained at approximately 16 gallons per minute. If the raw water source is fresh water, the flow rate for feed water entering the reverse osmosis unit is maintained near 80 gallons per minute. At a boosted pressure of 171 psi, the outflow of permeate is about 44 gallons per minute at a discharge pressure of about 20 psi. On the other hand, for a mid-range brackish water source, pressure is boosted to 181 psi, the outflow of permeate is still about 44 gallons per minute, and the discharge pressure is still about 20 psi. If the raw water source is seawater, then the feed pressure is boosted to 610 psi, the permeate output flow rate falls to about 34 gallons per minute, and the permeate discharge pressure is still about 20 psi.

The pressure vessels used to form first stage 122A and second stage 122B of the RO system are rated for an operating pressure of up to 1,200 psi. The vessel housings have side port style feed entry ports and are designed for Victaulic connections. The use of a 3:3 array configuration simplifies the piping connections as the vessels for each stage are stacked vertically rotated to allow the feed and concentrate ports to act as a manifold to distribute flow between the individual vessels. Thin film composite (TFC) membranes are used as the filtering mechanism for RO elements. T FC membranes consist of a thin membrane skin on a support backing, but the membrane skin is a different material than the support material. Materials used in TFC membranes include polyamides, polyuria, polypiperazineamide, and polysulfone. All of these materials are chlorine intolerant, i.e., free chlorine in the feed water causes irreversible damage to the element.

To minimize storage and logistics problems at deployment, only seawater type RO elements are used, e.g., Toray Model No. TM-820V. Seawater type elements are capable of operating at any system pressures that may be required (up to 1,200 psi). Although seawater type elements are not as energy efficient as RO elements designed for low total dissolved solids applications, the need to stock and distribute multiple types of membrane elements is thereby avoided. It also eliminates the possibility of low pressure elements being shipped for a deployment using seawater (or another high TDS water source), which would render the low pressure elements unusable.

The use of reverse osmosis removes dissolved solids from the feed water; in doing so, alkalinity components of the feed water are removed or reduced. In turn, this can lower the pH of the finished water to a corrosive, acidic state. The addition of chemicals such as sodium hydroxide (caustic soda) may be necessary to raise the treated water pH to levels compatible with the Community's water distribution system. Accordingly, in FIG. 10, filtration module 26 includes a reservoir of hydrogen peroxide 190, along with metering pump 192, for raising the pH of the discharged effluent. When reverse osmosis being used, the control system actuates metering pump 192 to add hydrogen peroxide to the feed water being passed to the reverse osmosis unit to compensate for dissolved alkaline solids that will be removed by the reverse osmosis stages.

As noted above, each of the ultrafiltration banks 120A, 120B and 120C must be periodically backwashed to remove suspended solid particulates filtered from the feed water. FIG. 11 schematically represents one ultrafiltration vessel 200 during the normal filtering cycle. Within FIG. 11, the lower end of vessel 200 is the end through which feed water to be filtered is normally introduced. During a normal filtering cycle, feed valve 202 is opened, drain valve 204 is closed, and compressed air valve 206 is closed. The upper end of vessel 200 is the end through which filtered permeate is discharged during a normal filtration cycle through discharge line 208. During normal filtration cycles, backwash water fill valve 210 is open, and water treated by ultrafiltration is added to backwash tank 144 under the control of a float valve therein. It was mentioned above that vessel 200 includes a backwash outlet vent that can be used to create a small waste stream from the upper portion of its respective pressure vessel. In FIG. 11, this backwash outlet vent is identified as port 212. Vent valve 214 can be adjusted to control the waste stream, if any, conducted out of vessel 200 through vent port 212. Backwash valve 216 is closed during a normal filter cycle.

The backwash sequence will now be described in conjunction with FIG. 12. During the start of a backwash cycle, feed water valve 202 is closed, permeate discharge valve 210 is closed, and backwash valve 216 is opened. Backwash pump 146 is actuated to pump backwash water from tank 144 into vessel 200 from its upper end, i.e., the port which normally discharges permeate. As noted earlier in regard to FIG. 10, a source of chlorine 150 and metering pump 152 (not shown in FIG. 12) are provided to add chlorine to the backwash water being pumped by pump 146 during this step to disinfect and/or prevent microbial growth within the ultrafiltration vessel 200. The waste backwash water is discharged through the bottom of vessel 200; valve 204 is opened to drain the waste backwash water. This initial backwashing configuration is maintained for 30-60 seconds. The chlorine metering pump 152 (see FIG. 10) is disabled at the end of this step.

Next, with backwash water still present in vessel 200, compressed air valve 206 is opened, and compressed air is released into vessel 200 through its lower end using a flow rate of 12-14 scfm at a pressure of about 6 psi. The resulting air bubbles rise upwardly through the vessel, and scour the exterior walls of the fibers, removing suspended solids attached to the membranes. Vent valve 214 is preferably opened during this step in the backwash process. This air-scouring step is preferably performed for between 30-60 seconds. The source of compressed air supplies the ultrafiltration modules with pressurized airflow for backwash scouring and also supplies compressed air for pneumatic valve operation. The air compressor is preferably of the scroll compressor type commercially available from Air Squared, Inc. of Broomfield, Colo. The air compressor system is contained within filtration module 26 and runs on DC voltage. Since the filtration module includes a source of compressed air, most of the control valves provided within the filtration module are pneumatically powered.

Next, pump 146 is turned off, valve 206 is closed, and valve 204 is opened to drain any remaining water from vessel 200. This step takes about 40-60 seconds to perform. Following this drain step, vessel 200 is refilled with water from tank 144 by pump 146 through valve 216. In order to ensure that vessel 200 will be purged of any remaining free chlorine, sodium bisulfite is added to the fill water during this step. As shown in FIG. 12, reservoir 218 is a source of sodium bisulfite, and metering pump 220 is actuated during this refill step to pump sodium bisulfite into the fill water exiting pump 146. This step takes approximately 30-60 seconds to perform. Note that sodium bisulfite need not be pumped into the fill water if the reverse osmosis membranes are being bypassed.

Following the refill step, ultrafiltration vessel 200 is placed back into normal service. Feed valve 202 is opened; drain valve 204 is closed; compressed air valve 206 is closed; permeate valve 210 is opened; backwash valve 216 is closed; pump 146 is turned off; and metering pump 220 is turned off.

As noted above, the timing of the backwash cycles for UF banks 120A, 120 B and 120C is staggered so that the flow rate through filtration module 26 remains relatively constant. Based on a 30 minute filter cycle, one of the UF banks will enter backwash every 10 minutes, and will be out of service for about four minutes, including the time for the actuated valves to cycle.

Those skilled in the art will now appreciate that an improved mobile water purification system has been described that can economically and efficiently provide significant quantities of potable water from an impure and/or contaminated raw water source in the event of a natural or man-made disaster. The described mobile water purification system can easily be air-lifted to a site without the need to truck equipment to the site. Once set up, the disclosed system is capable of removing virtually all types of contaminants likely to be found in a raw water source.

The disclosed mobile water purification system operates in a manner that does not require a highly-trained on-site operator, and includes equipment needed to readily assess the characteristics of the raw water source. The disclosed system assists an operator in determining the nature of source of raw water, including identification of contaminants, and further assists the operator to configure the purification system rapidly and efficiently. Once set up, the disclosed system is able to automatically monitor and report on the quality of the raw water source and/or the quality of the treated water being produced by the system. The disclosed system provides the flexibility of using reverse osmosis membranes when needed, and bypassing them when they are not required. When reverse osmosis is required, the disclosed system minimizes the possibility that sensitive reverse osmosis membranes will be irreparably damaged by free chlorine introduced during backwash operations. The novel mobile water purification system applies advanced oxidation processes to break down organic matter before it can foul filtration membranes. In addition, the disclosed system operates in a relatively continuous fashion, rather than in a start-stop mode.

Incorporation of an office area into pre-treatment module 24, combined with the use of a programmable logic controller (PLC) system and remote monitoring capabilities, allows the disclosed water purification system to function well as a temporary mobile water purification system. These same features facilitate incorporation of the disclosed system into a permanent water treatment facility, while complying with all reporting requirements of the U.S. Environmental Protection Agency for community water supplies.

While the present invention has been described with respect to preferred embodiments thereof, such description is for illustrative purposes only, and is not to be construed as limiting the scope of the invention. Various modifications and changes may be made to the described embodiments by those skilled in the art without departing from the true spirit and scope of the invention as defined by the appended claims.

We claim:

1. A mobile water purification system comprising in combination:
a) a pump for pumping raw water from a raw water source;
b) a pre-treatment module having an input port coupled to the pump for receiving raw water, the pre-treatment module including an oxidation unit for oxidizing contaminants present in the raw water, and the pre-treatment module including an output port for discharging water therefrom;
c) a filtration module having an input port coupled to the output port of the pre-treatment module for receiving water discharged thereby, the filtration module removing contaminants from the water passing therethrough, the filtration module including an output port for discharging purified water therefrom;
d) a storage tank coupled to the output port of the filtration module for storing treated water.

2. The mobile water purification system recited by claim 1 wherein the pre-treatment module includes a separator for removing suspended solids present in the raw water received by the pre-treatment module.

3. The mobile water purification system recited by claim 2 wherein the separator is a centrifugal separator for separating solids suspended within the raw water.

4. The mobile water purification system recited by claim 3 further including a fine mesh screen disposed between the centrifugal separator and the output port of the pre-treatment module for removing suspended solids of a predetermined size from the water flowing through the pre-treatment module before being discharged from the output port thereof.

5. The mobile water purification system recited by claim 1 wherein the pump includes an inlet screen for preventing debris from entering the pump.

6. The mobile water purification system recited by claim 1 wherein the pump is a screw pump.

7. The mobile water purification system recited by claim 1 wherein said oxidation unit includes a source of ultraviolet light directed at water passing through the pre-treatment module for neutralizing microorganisms, and reducing total organic carbons, that may be present within such water.

8. The mobile water purification system recited by claim 7 wherein said oxidation unit further includes a source of hydrogen peroxide, and wherein said oxidation unit adds hydrogen peroxide to the water passing therethrough to oxidize organic and inorganic matter that may be present within such water.

9. A mobile water purification system comprising in combination:
a) a pump for pumping raw water from a raw water source;
b) a pre-treatment module having an input port coupled to the pump for receiving raw water, the pre-treatment module including an oxidation unit for oxidizing contaminants present in the raw water, and the pre-treatment module including an output port for discharging water therefrom;
c) a first filtration module having an input port coupled to the output port of the pre-treatment module for receiving water discharged thereby, the first filtration module removing contaminants from the water passing therethrough, the first filtration module including an output port for discharging purified water therefrom;
d) a second filtration module having an input port coupled to the output port of the pre-treatment module for receiving water discharged thereby, the second filtration module removing contaminants from the water passing therethrough, the second filtration module including an output port for discharging purified water therefrom;
d) a storage tank coupled to the output ports of the first and second filtration modules for storing treated water.

10. The mobile water purification system recited by claim 9 wherein each of the first and second filtration modules includes an ultrafiltration unit for removing bacteria, viruses, and suspended solids from the water passing therethrough.

11. The mobile water purification system recited by claim 10 wherein each of the first and second filtration modules includes a reverse osmosis unit for removing ionic compounds and salts from the water passing therethrough.

12. The mobile water purification system recited by claim 9 wherein each of the first and second filtration modules includes an ultrafiltration unit for removing antibiotics, bacteria, viruses, organics and dyes from the water passing therethrough.

13. The mobile water purification system recited by claim 12 wherein each of the first and second filtration modules includes a reverse osmosis unit for removing ionic compounds and salts from the water passing therethrough.

14. The mobile water purification system recited by claim 9 wherein each of the first and second filtration modules includes a chlorination unit for adding chlorine to the water passing therethrough.

15. A mobile water purification system comprising in combination:
a) a pump for pumping raw water from a raw water source;
b) a pre-treatment module having an input port coupled to the pump for receiving raw water, the pre-treatment module including a separator for removing suspended solids present in the raw water received by the pre-treatment module, and the pre-treatment module including an output port for discharging water therefrom;
c) a first filtration module having an input port coupled to the output port of the pre-treatment module for receiving water discharged thereby, the first filtration module removing contaminants from the water passing therethrough, the first filtration module including an output port for discharging purified water therefrom;
d) a second filtration module having an input port coupled to the output port of the pre-treatment module for receiving water discharged thereby, the second filtration module removing contaminants from the water passing therethrough, the second filtration module including an output port for discharging purified water therefrom;
d) a storage tank coupled to the output ports of the first and second filtration modules for storing treated water;
e) a first valve selectively coupling pressurized backwash fluid to the output port of the first filtration module;
f) a second valve selectively coupling pressurized backwash fluid to the output port of the second filtration module;
g) a third valve for selectively coupling the input port of the first filtration module to a drain;
h) a fourth valve for selectively coupling the input port of the second filtration module to the drain;
i) a control system operating the first, second, third and fourth valves to stagger the backwashing of the first and second filtration modules, wherein the first and third valves are opened during a first time period to backwash the first filtration module, while the second and fourth valves are closed to allow the second filtration module to filter water, and wherein the second and fourth valves are opened during a second time period to backwash the second filtration module, while the first and third valves are closed to allow the first filtration module to filter water.

16. The mobile water purification system recited by claim 15 including:
a) a source of compressed air;
b) a fifth valve coupled to the source of compressed air for selectively passing compressed air into the first filtration module when the first filtration module is being backwashed; and
c) a sixth valve coupled to the source of compressed air for selectively passing compressed air into the second filtration module when the second filtration module is being backwashed.

17. A mobile water purification system comprising in combination:
a) a pump for pumping raw water from a raw water source;
b) a pre-treatment module having an input port coupled to the pump for receiving raw water, the pre-treatment module including a separator for removing suspended solids present in the raw water received by the pre-treatment module, and the pre-treatment module including an output port for discharging water therefrom;
c) a filtration module having an input port coupled to the output port of the pre-treatment module for receiving water discharged thereby, the filtration module including an output port for discharging treated water therefrom, the filtration module including:
i) a fine filtration unit for filtering contaminants from the from the water passing therethrough, the fine filtration unit having an inlet coupled to the input port of the filtration module and having an outlet for supplying filtered feed water; and
ii) a reverse osmosis unit including a pressure-boosting pump and a reverse osmosis membrane for removing contaminants from water passing therethrough, the reverse osmosis unit including an inlet coupled to the outlet of the fine filtration unit for receiving filtered feed water therefrom, and an outlet for supplying permeate;
d) a storage tank for storing treated water;
e) a first valve for selectively coupling the outlet of the fine filtration unit to the inlet of the reverse osmosis unit;
g) a second valve for selectively coupling the outlet of the reverse osmosis unit to the storage tank to supply said permeate to the storage tank;
h) a third valve for selectively coupling the outlet of the fine filtration unit to the storage tank while bypassing the reverse osmosis unit;
i) a control system operatively coupled to the first, second, third valves to either bypass the reverse osmosis unit, or pass water through the reverse osmosis unit, depending upon the nature of the raw water source.

18. The mobile water purification system recited by claim 17 further including a TDS sensor electrically coupled to the control system and responsive to the level of total dissolved solids within said raw water for generating an electrical signal indicative thereof;
wherein the control system is responsive to the electrical signal generated by the TDS sensor for alternately passing water through the reverse osmosis unit, or bypassing, the reverse osmosis unit, during processing of such raw water.

19. The mobile water purification system recited by claim 18 wherein:
a) the control system is operatively coupled to the first, second, and third valves for selecting whether each of such valves is opened or closed;
b) the control system opening the first valve, opening the second valve, and closing the third valve when the TDS sensor indicates that the level of total dissolved solids within the raw water is above a predetermined level; and
c) the control system closing the first valve, closing the second valve, and opening the third valve when the TDS sensor indicates that the level of total dissolved solids within the raw water is at or below said predetermined level.

20. The mobile water purification system recited by claim 17 wherein the control system is operatively coupled to the pressure-boosting pump of the reverse osmosis unit, the control system disabling the pressure-boosting pump when the reverse osmosis unit is being bypassed, the control system enabling the pressure-boosting pump when the reverse osmosis unit is not being bypassed.

21. A method of operating a water purification system comprising the steps of:
a) pumping raw water from a raw water source to a filtration module;
b) passing water through a fine filtration unit of the filtration module during a plurality of filtering cycles to trap contaminants within the water passed therethrough, and discharging filtered water from the filtration unit during such filtering cycles;
c) passing the filtered water through a reverse osmosis unit to further remove contaminants from water passing therethrough, and discharging clean water from the reverse osmosis unit;
d) providing a source of backwash fluid;
e) adding chlorine to the backwash fluid to disinfect the fine filtration unit;
f) periodically backwashing the fine filtration unit with backwash fluid during a backwash cycle, the backwash cycle occurring between successive filtering cycles, to flush trapped contaminants from the fine filtration unit to waste;
g) draining the backwash fluid from the fine filtration unit following step f);
h) re-filling the fine filtration unit with fill water and sodium bisulfite following step g) to refill the fine filtration unit and to neutralize any remaining free chlorine left within the fine filtration unit by the backwash fluid; and
i) resuming a next successive filtering cycle following step h).

22. The method of operating a water purification system as recited in claim 21 including the further step of directing compressed air into the fine filtration unit during the backwash cycle to aid in removing suspended solids from the fine filtration unit.
